(19) United States
(12) Patent Application Publication
(10) Pub. No.: US 2003/0028792 A1
(43) Pub. Date: Feb. 6, 2003

(54) System, method, and computer program product for automatically inputting user data into internet based electronic forms

(75) Inventors: Gregory Maurice Plow, Gilroy, CA (US); Farrokh E. Pourmirzaie, San Jose, CA (US)

Correspondence Address: John L. Rogitz, Rogitz & Associates, Suite 3120, 750 B Street, San Diego, CA, 92101, US

(73) Assignee: International Business Machines Corportion, Armonk, NY (US)

(21) Appl. No.: 09/922,196

(22) Filed: Aug. 2, 2001

(51) Int. Cl. H04L 9/32

(52) U.S. Cl. 713/193; 345/744; 715/507

(57) ABSTRACT

A system and method for automatically inputting user data into Internet based electronic forms includes creating an autofill profile at a user computer. The autofill profile includes user information and is stored at the user computer. When electronic forms are encountered on the Internet, information from the autofill profile is used to automatically fill the input fields of the electronic form. The autofill profile is automatically updated with new user information each time an electronic form is submitted to a server, if the form includes new information manually input by the user.

### TECHNICAL FIELD

The present invention relates generally to Internet based electronic forms.

### BACKGROUND OF THE INVENTION

Utilization of the Internet for ordering products, subscribing to electronic magazines (e-zines), opening accounts, etc. has become increasingly popular for computer users all over the world. Part of this popularity can be attributed to the tremendous productivity and efficiency afforded by the electronic process over a corresponding paper process.

One major drawback to any of the above-described electronic transactions is the fact that each time a user orders a product via a different website (or subscribes to a different e-zine via a different website or opens a different account at a different website, etc.) he or she must supply information relevant to the transaction, e.g., name, home address, email address, phone number, credit card number, etc. Every time a user is required to supply this information via the Internet, he or she must manually enter this information using a keyboard. Certain systems, however, have been provided that allow a user to store relevant user information in a static profile within his or her computer. Information required to complete electronic forms (e-forms) encountered while online can be taken from the static profile and automatically inserted into the e-form. Unfortunately, as the user information changes, the user must manually reenter that information into the e-form and into his or her static profile.

Other systems have also been provided wherein servers maintain databases of the user information. Thus, the need for a particular customer to re-enter his or her information each time he or she conducts business with that website is alleviated. Unfortunately, in this situation, the user must compromise privacy, security, and efficiency by relinquishing control of his or her personal information.

### SUMMARY OF THE INVENTION

Having recognized the above drawbacks, the present invention provides the solutions noted below to one or more of them.

A method for automatically inputting user information to an electronic form provided to a user computer from a server includes receiving the electronic form that requires user input thereto at the user computer. User information is retrieved from within the user computer memory and automatically input to the electronic form. When the user manually inputs data to the form, the user information stored in the user computer memory is updated.

In a preferred embodiment, the user is allowed to edit the electronic form. Moreover, when the electronic form is submitted to the server, an autofill profile is created at the user computer. The user information is stored in the autofill profile. Preferably, a personal identification number (PIN) is established. The autofill profile is encrypted and saved at the user computer. Further access to the autofill profile is based on the PIN. Specifically, when another electronic form is transmitted from the server to the user computer, the user is required to enter the PIN. When the correct PIN is entered, the autofill profile is decrypted and the user information from the autofill profile is input to the electronic form.

In another aspect of the preferred embodiment of the present invention, a system for automatically inputting user information to an Internet based electronic form includes a server, a database connected to the server, and a user computer connected to the server via an Internet connection. The database stores plural electronic forms. Moreover, the server transmits the electronic forms to the user computer. The user computer includes a program for automatically inputting user information stored on the user computer to the electronic form and automatically selectively updating user information stored on the user computer.

In yet another aspect of the preferred embodiment of the present invention, a computer program device includes a computer readable means having logic means for receiving an electronic form at the user computer. The electronic form requires user information to be input thereto. The computer readable means further includes logic means for retrieving user information from the user computer memory and logic means for automatically inputting the user information to the electronic form. Also, included is logic means for updating the user information stored in the user computer memory based on user manipulation of the form.

In still another aspect of the preferred embodiment of the present invention, a method for automatically inputting user information to an electronic form provided to a user computer from a server includes receiving the electronic form at the user computer. The electronic form is automatically filled using an autofill profile. If necessary, manual user input to the form is entered and based on the manual user input, the autofill profile is updated.

In yet still another aspect of the preferred embodiment of the present invention, a method for completing electronic forms received at a computer includes receiving a first electronic form at the computer from a first server. User information is input to one or more input fields provided by the first electronic form and the first electronic form is returned to the first server with the user information. Then, a second electronic form is received at the computer from a second server. User information automatically appears in the input fields of the second electronic form.

The present invention will now be described, by way of example, with reference to the accompanying drawings, in which:

### BRIEF DESCRIPTION OF THE DRAWINGS

FIG. 1 is a block diagram of a system architecture;

FIG. 2 is a flow chart of the operating logic of the preferred embodiment of the present invention;

FIG. 3 is a view of a computer screen; and

FIG. 4 is a flow chart of the security logic of the preferred embodiment of the present invention.

### DESCRIPTION OF AN EMBODIMENT OF THE INVENTION

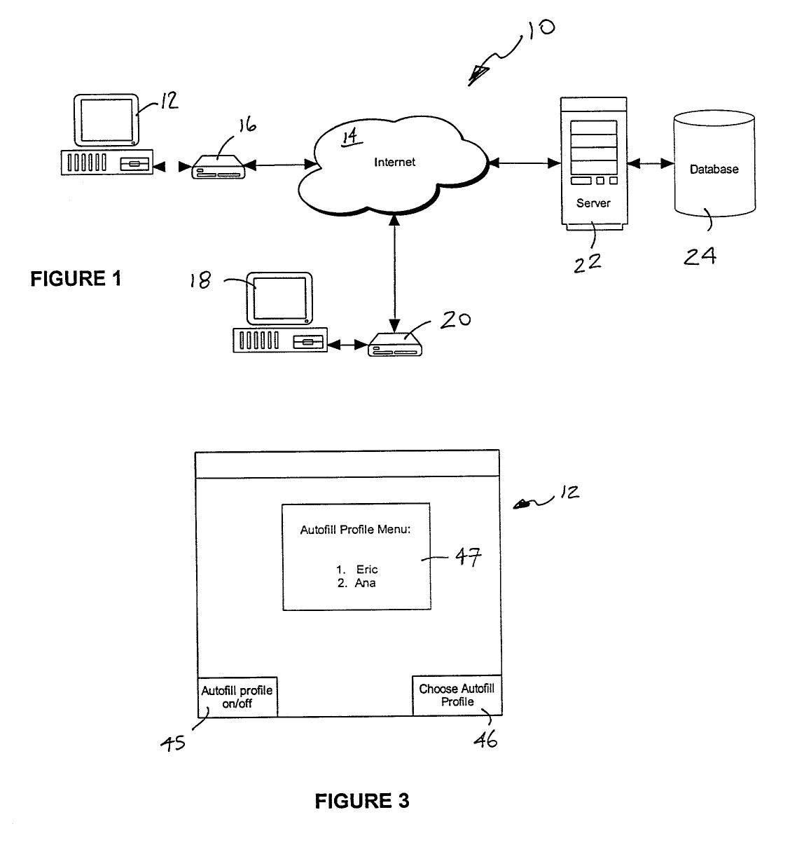

Referring initially to FIG. 1, a system is shown and generally designated 10. As shown in FIG. 1, the system 10 includes a first user computer 12 connected to the Internet 14 via a first modem 16. FIG. 1 also shows a second user computer 18 connected to the Internet 14 via a second modem 20. It can be appreciated that the modems 16, 20 can be telephone modems, cable modems, DSL modems, etc. that provide connections to the Internet 14 by telephone line, television cable, LAN, WAN, T1, or any other means well known in the art.

As shown in FIG. 1, a server 22 is also connected to the Internet 14. The server 22, in turn, is connected to a database 24. The server 22 transmits user requested information stored in the database 24 to the user computers 12, 18 via the Internet 14. In many cases, the server requires the user to fill out an electronic form (“e-form”) before the information is released or the service is performed. It is to be appreciated that numerous servers can be connected to the Internet to provide information and services to the user computers on a nearly infinite range of subjects.

While the preferred implementations of the user computers 12, 18 are personal computers manufactured by International Business Machines (IBM), the computers 12, 18 can be any computers, including Unix computers, or OS/2 servers, Windows NT servers, or laptop computer. (Unix is a registered trademark of The Open Group in the United States and other countries. OS/2 is a registered trademark of International Business Machines Corporation in the United States, other countries, or both. Windows NT is a trademark of Microsoft Corporation in the United States, other countries, or both.) Additionally, the computers 12, 18 can be hand held computers or any other devices that receive Internet content. Each user computer 12, 18 includes a series of computer-executable instructions, as described below, which will allow the user computer 12, 18 to automatically fill the input fields of electronic forms.

The instructions may be contained in random access memory (RAM) within each computer 12, 18 or on a data storage device with a computer readable medium, such as a computer diskette. Or, the instructions may be stored on a magnetic tape, conventional hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be written, e.g., in C++.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

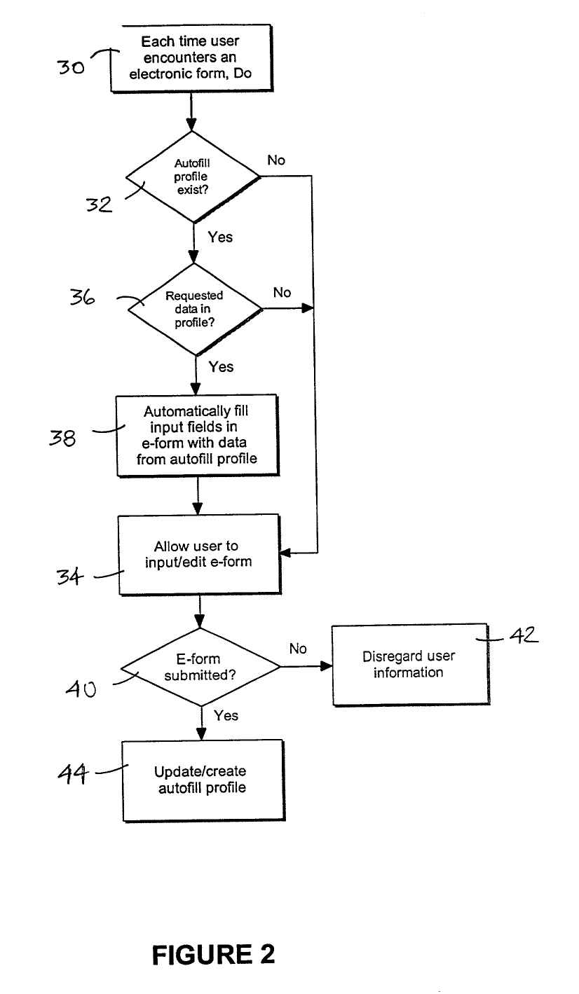

Referring to FIG. 2, the operating logic of the present invention is shown and commences at block 30 with a do loop, wherein each time a user encounters an e-form, the following steps are performed. At decision diamond 32, it is determined whether an autofill profile exists on the user computer 12. If not, the logic proceeds to block 34 where the user is allowed to manually enter the data into the e-form. If, at decision diamond 32, an autofill profile exists, the logic moves to decision diamond 36 where it is determined whether any data required by the e-form exists in the autofill profile. If not, the logic moves to block 34 and the user is allowed to manually enter the data into the e-form. If required data exists in the autofill profile on the user computer 12, the logic proceeds to block 38 where the input fields in the e-form are automatically filled with the data contained in the autofill profile. Thereafter, the logic moves to block 34 and the user is allowed to manually input required information and/or edit the e-form if there are any mistakes.

Continuing to decision diamond 40, it is determined whether the e-form is submitted to the server that transmitted it. If not, the user information is disregarded at block 42. If the e-form is submitted to the server, the logic proceeds to block 44 where the autofill profile contained on the user computer 12 is updated to include changed information or additional information from the submitted form. If an autofill profile does not exist, one is created at the user computer 12 using the information contained in the e-form.

When created/updated, the autofill profile contains personal information about a particular user. This information is organized as a set of input field variable name-value pairs. The input field variable names initially utilized by the default autofill profile will be the most commonly used variable names in the HTML INPUT tags. Completed fields in the autofill profile enable that information to be automatically input to e-forms encountered on the Internet. Fields that are left blank in the autofill profile will likewise remain blank if that corresponding information is requested on an e-form. It is to be understood that an initially empty (blank) autofill profile will become comprehensive over time as the learning characteristic eventually results in substantial profile information. There is no limit to the amount or type of information that could conceivably have value in the autofill profile.

Typically, a web programmer creates a field on the e-form with a HTML statement like:

<INPUT TYPE=TEXT NAME=FIRSTNAME VALUE=ERIC SIZE=30>

This exemplary, non-limiting statement is interpreted by the browser to be an input field that needs to be completed by the user. The field name is indicated by the NAME=attribute and its initial value, if any, is indicated by the VALUE=attribute. The final field value is determined by the user input in the field. As soon as the field is filled in by the user and the submit button is depressed, the input field variable name-value pair is transmitted to the requesting web server. A web programmer, utilizing this invention, is not required to do anything different on the back end of the system, i.e., business is as usual for the web programmer. Assuming that the autofill profile is activated by a user in his browser and an autofill profile is selected, each time the user accesses a web page containing an e-form, the browser checks to see if the selected autofill profile exists. If so, it checks to see if the autofill profile contains an entry for the field name identified by the Name=attribute of each INPUT HTML tag within the e-form. If so, the browser automatically retrieves the corresponding field value from the autofill profile and fills in the associated input field in the e-form. Any fields not automatically completed or fields completed, but in need of correction can be further edited by the user utilizing current methods prior to submitting or returning the e-form to the server. Upon submission of a completed e-form, the browser automatically updates the autofill profile to include an entry for each input field name-value pairs within the e-form. Input fields left blank in the e-form will not result in corresponding changes to the autofill profile (i.e. there is nothing to learn from a field that is left blank).

It is to be understood that a default autofill profile can be created using the most popular field names, e.g., “first name=,” based on user provided information in response to queries provided by the browser during the initial set-up of the browser software at the user site. For example, a user can be asked to enter his or her name, age, social security number, home address, email address, and other relevant information. Then, this information can be used to create an autofill profile. On the other hand, the browser can include a utility program that allows a user to set up and edit an autofill profile at any time.

Referring to FIG. 3, it is shown that the browser utilized by, e.g., the first user computer 12, can also include an autofill profile “On/Off” button 45 that can be toggled by a user in order to activate and deactivate the autofill profile. Thus, when a user other than the regular user of a particular computer is using the computer to conduct business via the Internet, he or she can turn off the functionality afforded by the autofill profile so that the regular user's information will not be automatically provided to e-forms encountered by the alternate user.

It is also to be understood that in the situation of multiple regular users of a particular computer, e.g., a family owned computer, multiple autofill profiles can be created so that each user has his or her own autofill profile. Moreover, a “Choose Autofill Profile” button 46 can be provided. When the “Choose Autofill Profile” button 46 is toggled or otherwise selected, a menu of user names 47 can be provided with each user name corresponding to a particular autofill profile. Thus, before conducting business online, a particular user can select his or her name from the menu 47 so that the autofill profile corresponding to that name provides is used to provide information to any e-forms encountered.

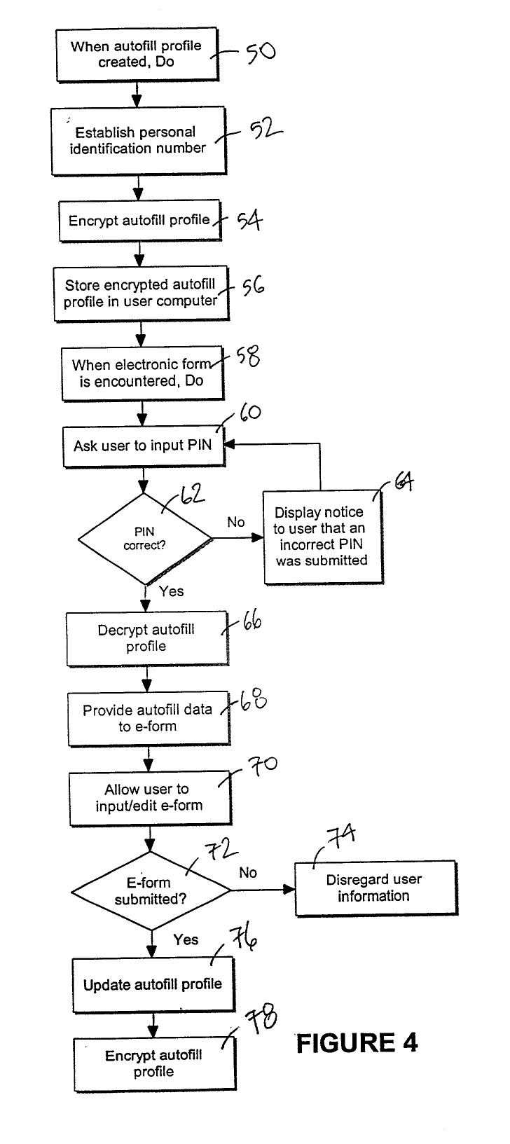

Referring now to FIG. 4, the security logic of the present invention is shown and commences at block 50 with a do loop, wherein when the autofill profile is created, the succeeding steps are performed. At block 52, a personal identification number (PIN) for a specific user is established. The PIN can be chosen by the user, or the PIN can be automatically generated and provided to the user. Next, at block 54, the autofill profile is encrypted preferably using the PIN. At block 56, the encrypted autofill profile is stored at the user computer 12.

Proceeding to block 58, a do loop is entered wherein when an e-form is encountered on the Internet, the following steps are performed. At block 60, the user is asked to input his or her PIN. At decision diamond 62 it is determined whether this PIN is correct. If an incorrect PIN is entered, the logic moves to block 64 where a notice is displayed to the user that an incorrect PIN has been entered. Then, the logic returns to block 60 and the user is again asked to enter his or her PIN. If at decision diamond 62, a correct PIN is entered, the logic continues to block 66 where the autofill profile is decrypted. At block 68, the decrypted data is then automatically entered into the input fields provided by the e-form.

Proceeding to block 70, the user is allowed to manually input required information and/or edit the e-form if there are any mistakes. Next, at decision diamond 72, it is determined whether the e-form is submitted to the server that transmitted it. If not, the user information is disregarded at block 74. If the e-form is submitted to the server, the logic proceeds to block 76 where the autofill profile contained on the user computer 12 is updated to include changed information or additional information from the submitted form. Thereafter, at block 78, the updated autofill profile is encrypted.

It is to be understood that the user data necessary to complete the e-form described above can include, but is not limited to, the following: name, address, social security number, home phone number, business phone number, email address, credit card number, age, number of adults in household, number of children in household, number of vehicles owned, number of computers owned, whether the user rents or own his or her home, hobbies, etc.

With the configuration of structure described above, it is to be appreciated that system and method described above provides a means for automatically inputting user information to e-forms. Thus, each time a user encounters an e-form on the Internet, he or she does not have to manually enter all or any of the information required to complete the e-form.

While the particular SYSTEM, METHOD, AND COMPUTER PROGRAM PRODUCT FOR AUTOMATICALLY INPUTTING USER DATA INTO INTERNET BASED ELECTRONIC FORMS as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

We claim:

1. A method for automatically inputting user information to an electronic form provided to a user computer from a server, comprising the acts of:
receiving the electronic form at the user computer, the electronic form requiring user information to be input thereto;
retrieving user information from memory;
automatically inputting the user information to the electronic form; and
updating the user information stored in the user computer in response to a user manually inputting data to the form.

2. The method of claim 1, further comprising the act of:
allowing the user to edit the electronic form.

3. The method of claim 1, further comprising the act of:
receiving a second electronic form, the second electronic form requiring user information to be input thereto;
retrieving updated user information from memory; and
automatically inputting the updated information to the second electronic form.

4. The method of claim 1, further comprising the act of:
when the electronic form is submitted to the server, selectively creating an autofill profile at the user computer, the user information being stored in the autofill profile.

5. The method of claim 4, further comprising the act of:
establishing a personal identification number (PIN).

6. The method of claim 5, further comprising the act of:
encrypting the autofill profile; and
saving the autofill profile, further access to the information within the autofill profile being at least partially based on the PIN.

7. The method of claim 6, further comprising the act of:
when another electronic form is transmitted from the server to the user computer, selectively requiring the user to enter the PIN.

8. The method of claim 7, further comprising the act of:
when a correct PIN is entered, decrypting the autofill profile; and
automatically inputting user information from the autofill profile to the electronic form.

9. A system for automatically inputting user information to an Internet based electronic form, comprising:
at least one server;
at least one database connected to the server, the database storing plural electronic forms; and
at least one user computer connected to the server via an Internet connection, the server transmitting at least one electronic form to the user computer, the user computer including a program for automatically inputting user information stored on the user computer to the electronic form and automatically selectively updating user information stored on the user computer.

10. The system of claim 9, wherein the program includes:
logic means for receiving the electronic form at the user computer, the electronic form requiring user information to be input thereto;
logic means for retrieving user information from memory;
logic means for automatically inputting the user information to the electronic form; and
logic means for updating the user information stored in the user computer in response to a user manually inputting data to the form.

11. The system of claim 10, wherein the program further includes:
logic means for allowing the user to edit the electronic form.

12. The system of claim 10, wherein the program further includes:
logic means for selectively creating an autofill profile at the user computer when the electronic form is submitted to the server, the user information being stored in the autofill profile.

13. The system of claim 12, wherein the program further includes:
logic means for establishing a personal identification number (PIN).

14. The system of claim 13, wherein the program further includes:
logic means for encrypting the autofill profile; and
logic means for saving the autofill profile.

15. The system of claim 14, wherein the program further includes:
logic means for selectively requiring the user to enter the PIN when another electronic form is transmitted from the server to the user computer.

16. The system of claim 15, wherein the program further includes:
logic means for decrypting the autofill profile when a correct PIN is entered; and
logic means for automatically inputting user information from the autofill profile to the electronic form.

17. A computer program device, comprising:
a computer readable means having logic means for storing user information in an autofill profile at a user computer, comprising:
logic means for receiving the electronic form at the user computer, the electronic form requiring user information to be input thereto;
logic means for retrieving user information from memory;
logic means for automatically inputting the user information to the electronic form; and
logic means for updating the user information stored in the user computer based on user manipulation of the form.

18. The program device of claim 17, wherein the computer readable means further includes:
logic means for allowing the user to edit the electronic form.

19. The program device of claim 18, wherein the computer readable means further includes:
logic means for selectively creating an autofill profile at the user computer when the electronic for m is submitted to the server, the user information being stored in the autofill profile.

20. The program device of claim 19, wherein the computer readable means further includes:
logic means for establishing a personal identification number (PIN).

21. The program device of claim 20, wherein the computer readable means further includes:
logic means for encrypting the autofill profile; and
logic means for saving the autofill profile.

22. The program device of claim 21, wherein the computer readable means further includes:
logic means for selectively requiring the user to enter the PIN when another electronic form is transmitted from the server to the user computer.

23. The program device of claim 22, wherein the computer readable means further includes:
logic means for when a correct PIN is entered, decrypting the autofill profile; and
logic means for automatically inputting user information from the autofill profile to the electronic form.

24. A method for automatically inputting user information to an electronic form provided to a user computer from a server, comprising the acts of:
receiving the electronic form at the user computer, the electronic form requiring user information to be input thereto;
automatically filling the form using an autofill profile;
receiving user input to the form; and
based on the user input, updating the autofill profile.

25. A method for completing electronic forms received at a computer, comprising the acts of:
receiving a first electronic form at the computer, the first electronic form being transmitted by a first server;
inputting user information into at least one input field provided by the first electronic form;
returning the first electronic form to the first server with the user information; and
receiving a second electronic form at the computer, the second electronic form being transmitted by a second server, the user information automatically appearing in at least one input field of the second electronic form.

26. The method of claim 25, further comprising the act of:
editing at least one of: the first electronic form or the second electronic form.

27. The method of claim 25, further comprising the act of:
establishing a personal identification number (PIN) corresponding to the user information.
